(19) United States
(12) Patent Application Publication
(10) Pub. No.: US 2015/0062791 A1
(43) Pub. Date: Mar. 5, 2015

(54) Absorbent Grip System

(71) Applicant: SweatAwayUSA LLC, Cheyenne, WY (US)

(72) Inventor: Robbin Cooley, Cheyenne, WY (US)

(73) Assignee: SweatAwayUSA LLC, Cheyenne, WY (US)

(21) Appl. No.: 14/473,777

(22) Filed: Aug. 29, 2014

Related U.S. Application Data
(60) Provisional application No. 61/872,468, filed on Aug. 30, 2013.

(51) Int. Cl. G06F 1/16; A47K 7/02; A47K 10/14; A63B 26/00

(52) U.S. Cl. CPC G06F 1/1656; A63B 26/00; A47K 7/028; A47K 10/14; G06F 1/163
USPC 361/679.03; 16/110.1; 16/422; 16/111.1

(57) ABSTRACT

Generally, an absorbent grip system including an absorbent element coupled to a grippable body configured for gripping by a gripping element to engage the absorbent element with a contactable surface to absorb or displace fluids or solid substances from the contactable surface. Specifically, an absorbent element coupled to a grippable body configured for gripping by a hand to engage the absorbent element with a skin surface to absorb or displace fluids or solid substances from the skin surface.

This United States Non-Provisional Patent Application claims the benefit of U.S. Provisional Patent Application No. 61/872,468, filed Aug. 30, 2013, hereby incorporated by reference herein.

### I. BACKGROUND

Conventional encircling strips, such as headbands or wristbands correspondingly worn about the head or wrist, may be made from a variety of materials depending on the application. For example, embodiments designed from absorbent materials, such as a terrycloth material, may be used to absorb or wipe sweat from a user's body, such as a user's forehead, during physical activity, such as exercise or sport.

However, headbands or wristbands remain generally statically disposed on substantially one area of the user's body, thereby not moving or being moved over the skin surface to absorb or displace fluids or solid substances. Accordingly, a need exists for an absorbent system including an absorbent element coupled to a grippable body which could be carried by a user during an activity, whereby the absorbent element may be moved over the skin surface to absorb or displace fluids or solid substances from the skin surface of the user.

### II. SUMMARY OF THE INVENTION

A broad object of a particular embodiment of the invention can be to provide an absorbent grip including a grippable body having a grippable body length disposed between a grippable body first end and a grippable body second end, the grippable body having a grippable body medial portion configured to be gripped by a gripping element; and an absorbent element coupled to the grippable body first end.

Another broad object of a particular embodiment of the invention can be to provide an absorbent grip including an interior chamber disposed within the grippable body, the interior chamber having an interior chamber volume defined by an interior chamber wall configured to allow removable insertion and retention of an associated device.

Another broad object of a particular embodiment of the invention can be to provide a method of producing an absorbent grip, the method including providing a grippable body having a grippable body length disposed between a grippable body first end and a grippable body second end, the grippable body having a grippable body medial portion configured to be gripped by a gripping element; and coupling an absorbent element to the grippable body first end.

Another broad object of a particular embodiment of the invention can be to provide a method of using an absorbent grip, the method including grippably engaging a grippable body; and contacting an absorbent element coupled to a grippable body first end with a contactable surface, the absorbent element configured to absorb or displace fluids or solid substances from the contactable surface.

Naturally, further objects of the invention are disclosed throughout other areas of the specification, drawings, and claims.

### III. A BRIEF DESCRIPTION OF THE DRAWINGS

FIG. 1 is an illustration of a method of using an embodiment of the inventive absorbent grip.

FIG. 2 is an exploded perspective front view of a particular embodiment of the inventive absorbent grip.

FIG. 3 is a front view of a particular embodiment of the inventive absorbent grip.

FIG. 4 is back view of a particular embodiment of the inventive absorbent grip.

FIG. 5 is a first side view of a particular embodiment of the inventive absorbent grip.

FIG. 6 is a second side view of a particular embodiment of the inventive absorbent grip.

FIG. 7 is a top view of a particular embodiment of the inventive absorbent grip.

FIG. 8 is a bottom view of a particular embodiment of the inventive absorbent grip.

FIG. 9 is an exploded perspective view of a particular embodiment of the inventive absorbent grip.

FIG. 10 is front view of a particular embodiment of the inventive absorbent grip.

FIG. 11 a bottom view of a particular embodiment of the inventive absorbent grip.

FIG. 12 is a block diagram of a particular embodiment of a computing element coupled to the inventive absorbent grip, whereby the computing element has a computer program code contained in a memory element in communication with a processor, the computer program code executable to provide a variety of sensing, measuring, or guiding functions.

### IV. DETAILED DESCRIPTION OF THE PREFERRED EMBODIMENTS

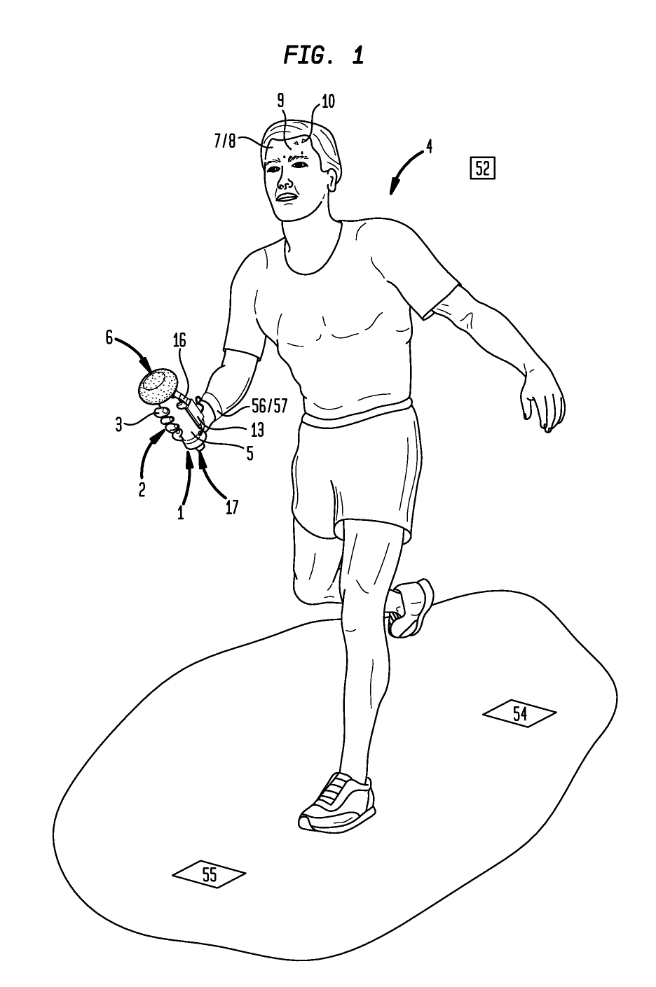

Now referring primarily to FIG. 1, which illustrates a method of using a particular embodiment of an inventive absorbent grip (1) in association with a gripping element (2), such as a hand (3) of a user (4). The hand (3), by grippably engaging a grippable body (5) of the absorbent grip (1), can secure the grippable body (5), which can then be gripped and carried by the user (4). In the example of FIG. 1, an absorbent element (6) coupled to the grippable body (5) can be moved by corresponding movement of the grippable body (5) to contact the absorbent element (6) with a contactable surface (7), such as a portion of a skin surface (8) of the user (4). The absorbent element (6) can remain in static or movable contact with the contactable surface (7), such as the skin surface (8) of the user (4), for a period of time to absorb or displace fluid (9) or solid substances (10), such as sweat, liquid, solid particulates, or the like, or combinations thereof, from the skin surface (8), or other contactable surface (7).

While the gripping element (2) shown in FIG. 1 is depicted as a hand (3) of a user (4), the gripping element (2) can take any form capable of or adapted to grip or secure an embodiment of the absorbent grip (1), such as prosthetic limbs or hands, mechanical grippers whether having a rigid structure or movable parts, straps, catches, pockets, matable parts of hook and loop fasteners, or the like. Additionally, while FIG. 1 shows the user (4) gripping an embodiment of the absorbent grip (1) in the hand (3) while running, the invention need not be so limited with respect to the numerous and varied methods of using the absorbent grip (1). Rather, the illustrative method of using a particular embodiment of the absorbent grip (1) as shown in the example of FIG. 1 and as described in the description set forth herein is intended to enable a person of ordinary skill in the art to make a numerous and wide variety of embodiments of the absorbent grip (1) for a correspondingly numerous and wide variety of uses or activities in which an absorbent grip (1) may be useful.

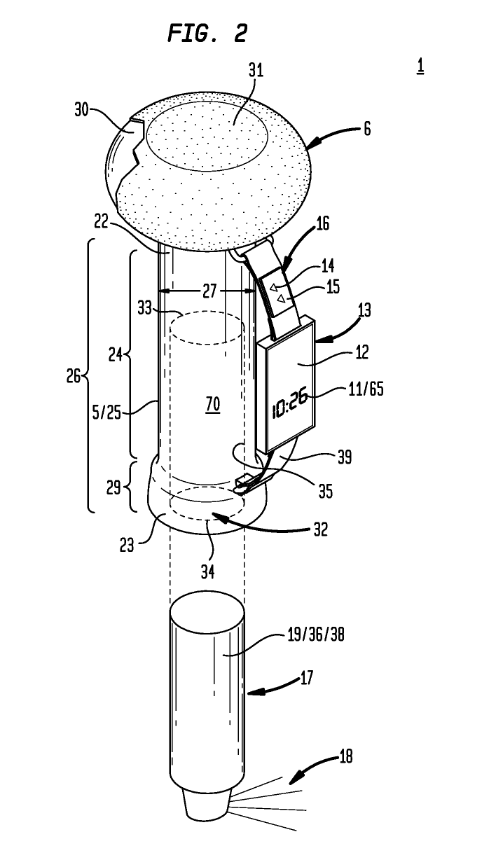

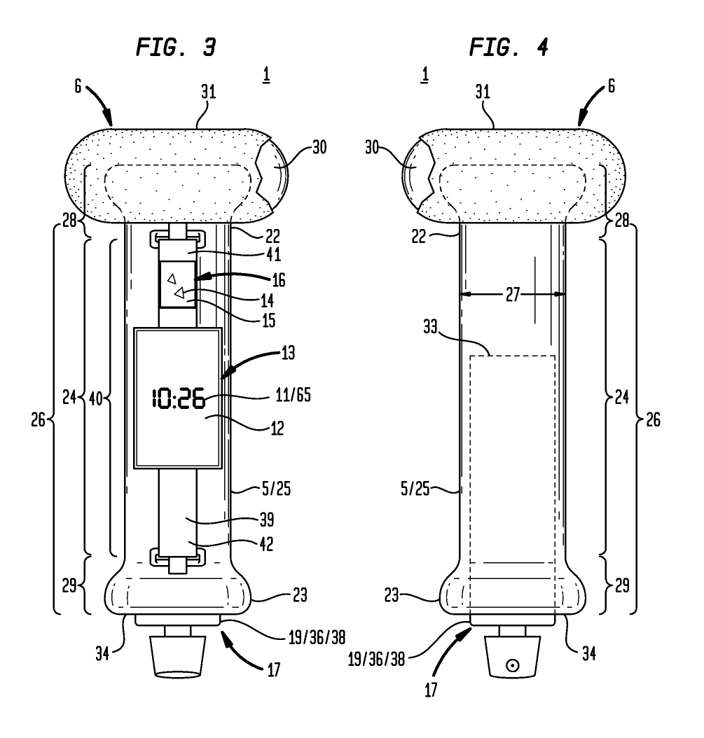

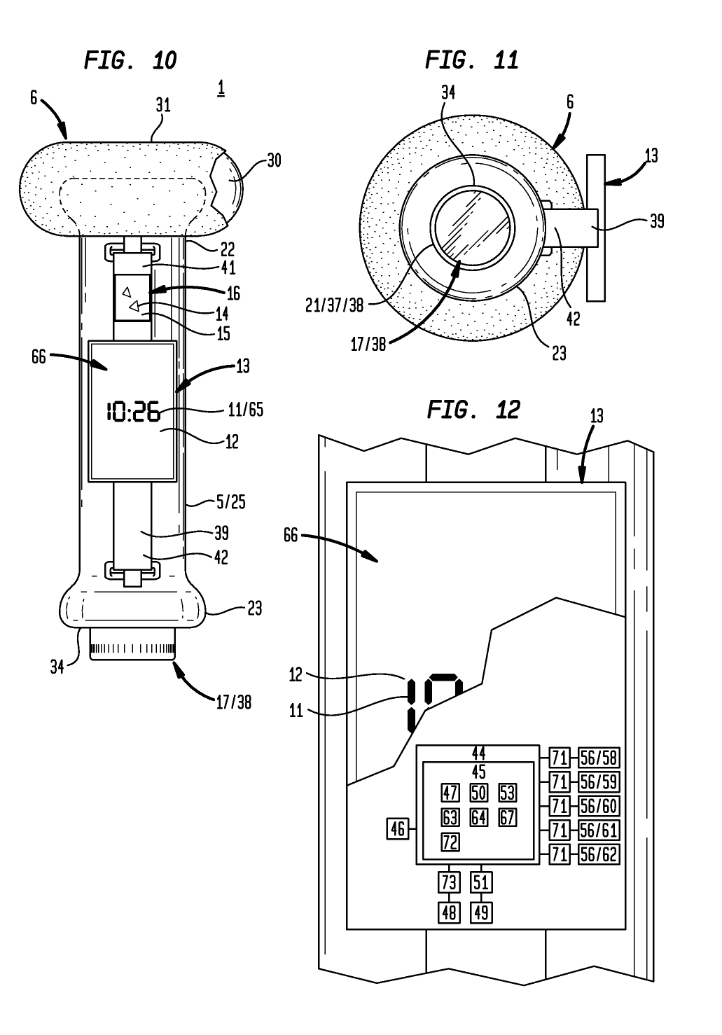

Now referring primarily to FIG. 2 through FIG. 11, embodiments of the absorbent grip (1) can include a grippable body (5) having a grippable body length (26) disposed between a grippable body first end (22) and a grippable body second end (23). The grippable body (5) can have a grippable body medial portion (24) having an external surface (25) configured to be gripped by a gripping element (2). As to particular embodiments, the external surface (25) can be configured to be gripped by a hand (3) of a user (4).

As to particular embodiments, the grippable body medial portion (24) can be configured as a generally elongate cylinder having a cylinder diameter (27) typically in a range of between about 25 millimeters (about 1 inch) to about 50 millimeters (about 2 inches). The cylinder diameter (27) can be selected from the group including or consisting of: between about 25 millimeters to about 30 millimeters; between about 27.5 millimeters to about 32.5 millimeters; between about 30 millimeters to about 35 millimeters; between about 32.5 millimeters to about 37.5 millimeters; between about 35 millimeters to about 40 millimeters; between about 37.5 millimeters to about 42.5 millimeters; between about 40 millimeters to about 45 millimeters; between about 42.5 millimeters to about 47.5 millimeters; and between about 45 millimeters to about 50 millimeters, whereby a lesser cylinder diameter (27) can be capable of accommodating a hand (3) having lesser dimensional relations in relation to a hand (3) having greater dimensional relations, which can be accommodated by an absorbent grip (1) having a greater cylinder diameter (27).

As to particular embodiments, the grippable body length (26) between the grippable body first end (22) and the grippable body second end (23) can typically be in a range of between about 100 millimeters (about 4 inches) to about 150 millimeters (about 6 inches). The grippable body length (26) can be selected from the group including or consisting of: between about 100 millimeters to about 115 millimeters; between about 112.5 millimeters to about 117.5 millimeters; between about 115 millimeters to about 120 millimeters; between about 117.5 millimeters to about 122.5 millimeters; between about 120 millimeters to about 125 millimeters; between about 122.5 millimeters to about 127.5 millimeters; between about 125 millimeters to about 130 millimeters; between about 127.5 millimeters to about 132.5 millimeters; between about 130 millimeters to about 135 millimeters; between about 132.5 millimeters to about 137.5 millimeters; between about 135 millimeters to about 140 millimeters; between about 137.5 millimeters to about 142.5 millimeters; between about 140 millimeters to about 145 millimeters; between about 142.5 millimeters to about 147.5 millimeters; and between about 145 millimeters to about 150 millimeters, whereby a lesser grippable body length (26) can be capable of accommodating a hand (3) having lesser dimensional relations in relation to a hand (3) having greater dimensional relations, which can be accommodated by an absorbent grip (1) having a greater grippable body length (26).

As to particular embodiments, the grippable body medial portion (24) can be disposed between grippable body first and second terminal portions (28)(29), whereby one or both of the grippable body first and second terminal portions (28)(29) can have a greater cylinder diameter (27) than the grippable body medial portion (24) to assist the user (4) in maintaining grippable engagement with the grippable body (5).

The grippable body (5) can be fabricated, formed, molded, or otherwise produced from one or more of a wide variety of materials, such as: metal, plastic, elastomer, glass, thermoplastic, thermoplastic composite, polypropylene, fluorocarbon, polycarbonate, polymethylpentane, polyvinylchloride, polyethylene, polytetrafluoroethylene, silicone, polyacetal, polyisoprene, polybutadiene, chloroprene, butyl rubber, nitrile rubber, silicon rubber, or the like, or combinations thereof. As to particular embodiments, the grippable body (5) can be produced from a lower durometer material, which can assist the user (4) in maintaining grippable engagement with the grippable body (5) or enhance comfort when the user (4) maintains grippable engagement with the grippable body (5).

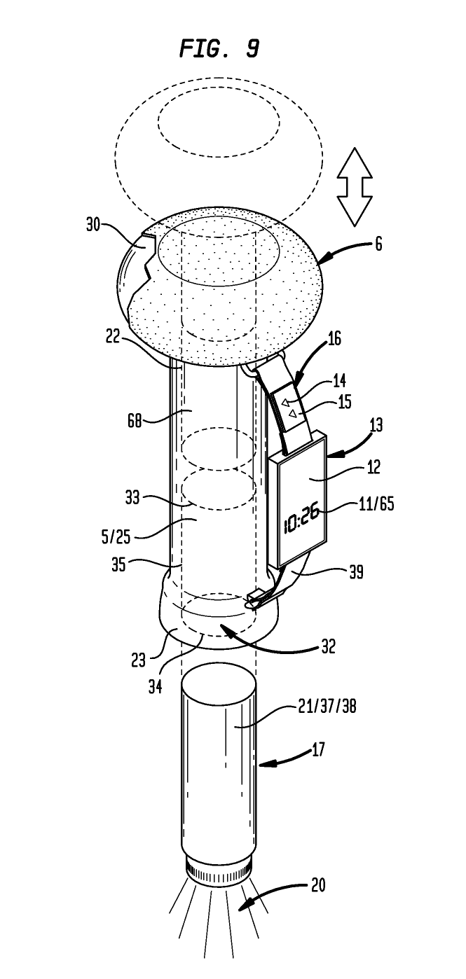

As shown in FIG. 2 through FIG. 11, the absorbent grip (1) can further include an absorbent element (6) coupled to the grippable body first end (22), whether directly or indirectly. As to particular embodiments, the absorbent element (6) can be coupled to the grippable body first end (22) by overlaying a support element (30). As an illustrative example, the support element (30) can take the form of an enlarged grippable body first terminal portion (28), which can be overlaid by the absorbent element (6). As to other particular embodiments, the support element (30) can be coupled to the grippable body first end (22) to provide a sufficiently large volume to overlay with the absorbent element (6). As to yet other particular embodiments, the support element (30) can be coupled to an elongate member (68) telescopically engaged with the grippable body (5) (as shown in the example of FIG. 9), whereby the absorbent element (6) overlaying the support element (30) coupled to the elongate member (68) can be removed as a unitary assembly from the grippable body (5). Upon telescopic engagement of the elongate member (68) with the grippable body (5), the absorbent element (6) can be disposed proximate the grippable body first end (22).

The support element (30) can be of fabricated, formed, molded, or otherwise produced from any material capable of supporting the overlaid absorbent element (6), such as: an open-cell foam, a closed-cell foam, a sponge, an expanded rubber, a latex foam, or the like, or combinations thereof.

The absorbent element (6) can be of any material having a capacity or tendency to absorb or displace a fluid (9) or solid substance (10), as above described. As illustrative examples, the absorbent element (6) can be made from a naturally occurring material or associated fibers such as cotton, linen, cellulose, bamboo, chitosan, or the like, or non-naturally occurring materials or associated fibers such as polyacrylate, a terpolymer of acrylic acid, polyacrylate, polyacrylamide, cellulosic, or the like, or combinations thereof.

As to particular embodiments, the absorbent element (6) can be configured as a reusable absorbent element (6), which can be removed from the support element (30) for cleaning and again overlaid on the support element (30). As to other particular embodiments, the absorbent element (6) can be configured as a disposable absorbent element (6), which can be removed from the support element (30), disposed of, and another disposable absorbent element (6) can be overlaid on the support element (30).

Again referring to primarily FIG. 2 through FIG. 11, the absorbent element (6) can be configured for static or movable contact with a contactable surface (7) from which fluid (9) or solid substances (10) can be absorbed or displaced. As to particular embodiments, the absorbent element (6) can have a generally planar absorbent face (31). As an illustrative example, the generally planar absorbent face (31) can include a generally circular periphery, whereby the generally planar absorbent face (31) can have a face diameter (69) about twice the cylinder diameter (27) of the of the grippable body (5) for contact with the skin surface (8) of a user (4). However, the invention need not be so limited, as the generally planar absorbent face (31) can include a periphery configured in any of a numerous and wide variety of configurations and dimensional relations suitable for coupling to the grippable body (5) and capable of absorbing or displacing fluid (9) or solid substances (10).

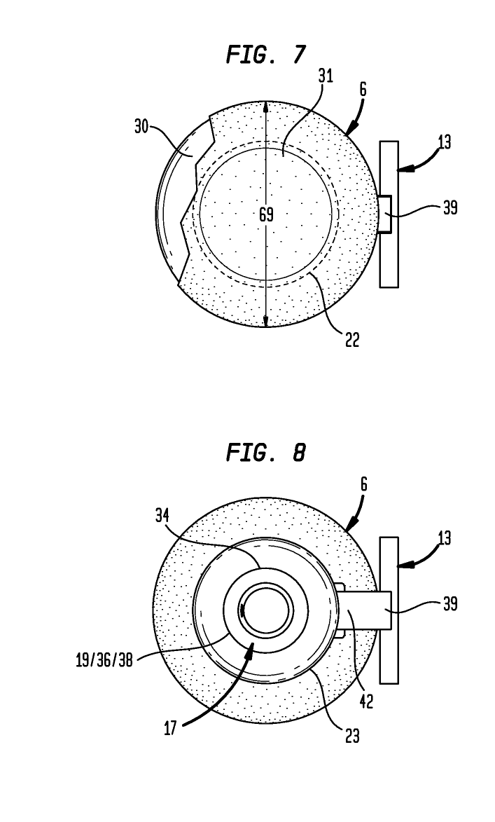

Now referring primarily to FIG. 2 and FIG. 7, the grippable body (5) can further include an interior chamber (32). As to particular embodiments, the interior chamber (32) within the grippable body (5) can be configured with a closed end (33) disposed a distance toward the grippable body first end (22) and an open end (34) allowing ingress and egress from the grippable body second end (23). The interior chamber (32) can have an interior chamber volume (70) defined by an interior chamber wall (35) which can be configured to allow removable insertion and retention of an associated device (17).

Now referring primarily to FIG. 2, as to particular embodiments, the associated device (17) can be a container (19), whether pressurized or non-pressurized, operable by the user (4) to disperse a contained fluid (18). The interior chamber wall (35) can be configured to sufficiently slidably engage a container external surface (36) to allow removable insertion of the container (19) within the interior chamber (32) and retention of the container (19) within the interior chamber (32) during normal use of the absorbent grip (1).

Now referring primarily to FIG. 9, as to particular embodiments, the associated device (17) can be a light source (21) operable by the user (4) to generate a beam of light (20). The interior chamber wall (35) can be configured to sufficiently slidably engage a light source external surface (37) to allow removable insertion of the light source (21) within the interior chamber (32) and retention of the light source (21) within the interior chamber (32) during normal use of the absorbent grip (1).

Understandably, the absorbent grip (1) can include a plurality of associated devices (17) each having an associated device external surface (38) of similar configuration for interchangeable removable insertion and retention within the interior chamber (32) of the grippable body (5). The plurality of associated devices (17) having associated device external surfaces (38) of similar configuration can include as examples: a container (19), a light source (21), weights, self-defense devices, or the like, or combinations thereof

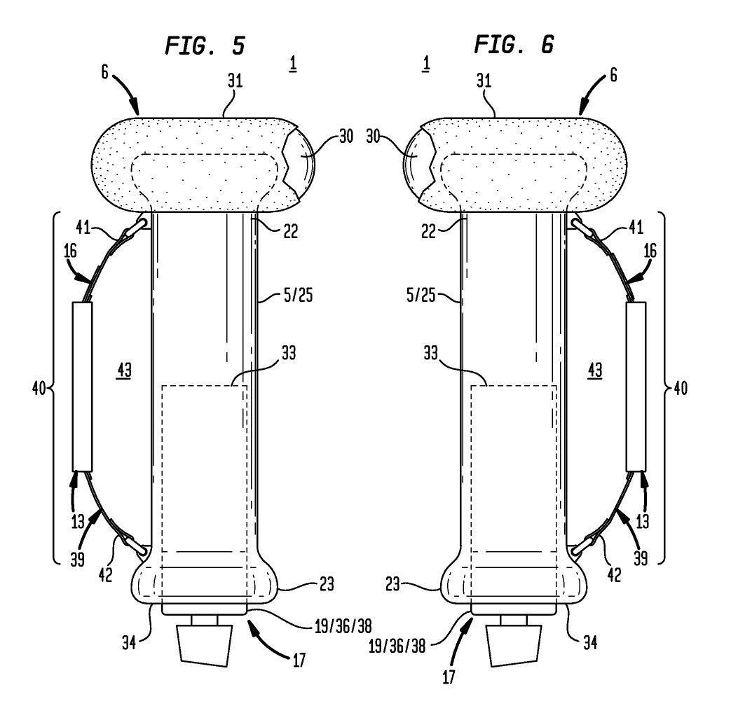

Now referring primarily to FIG. 2 through FIG. 11, particular embodiments of the absorbent grip (1) can further include a strap (39) having a strap length (40) disposed between a pair of strap ends (41)(42) correspondingly coupled proximate the grippable body first end (22) and the grippable body second end (23). The strap length (40) can be adjusted to engage a hand (3) of a user (4) to assist in maintaining grippable engagement with the grippable body (5). While the illustrative strap (39) shown in the Figures is configured as an elongate band, the invention need not be so limited, as the strap (39) can be configured in any manner capable of coupling to the grippable body (5) to provide a pass-through (43) for the hand (3) of the user (4) (as shown in the examples of FIG. 5 and FIG. 6).

Again referring primarily to FIG. 2 through FIG. 11, embodiments of the absorbent grip (1) can further include a reflective element (16) which can be mounted on the absorbent grip (1). The reflective element (16) can provide a reflective surface (15) positionable by a user (4) to view reflective indicia (14). While the embodiment of the absorbent grip (1) shown in the figures has the reflective element (16) mounted on the strap (39), the invention need not be so limited, as embodiments of the absorbent grip (1) can have a reflective element (16) mounted at any location useful for viewing reflective indicia (14), including the grippable body (5), the absorbent element (6), the strap (39), the associated devices (17), or the like, or combinations thereof.

The reflective element (16) can be fabricated, formed, molded, or otherwise produced from a wide variety of reflective materials, for example metals such as aluminum, silver, gold, or chrome, plastics such as polyester or acrylic, glass, or the like, or combinations thereof

Again referring primarily to FIG. 2 through FIG. 11, embodiments of the absorbent grip (1) can further include a computing element (13) having a memory element (44) containing a computer program code (45). A processor (46) in communication with the memory element (44) can operate to execute the computer program code (45) to generate one or more viewable indicia (11) on a display surface (12), for example a display surface (12) of the computing element (13).

As to particular embodiments, the computer program code (45) can include a timer module (47) which upon execution functions to display a date or time, a measure of time, or the like, or combinations thereof.

As to particular embodiments, the computing element (13) can further include or be coupled to, whether wired or wirelessly, an global positioning sensor (48) and the computer program code (45) can include a global positioning module (48), which upon execution allows the user (4) to determine the location of the absorbent grip (1) based on a global positioning sensor signal (73) generated by the global positioning sensor (48). As to particular embodiments, the global positioning module (48), in cooperative action with the timer module (47), can determine a pace or rate of travel, a count of steps, a current elevation, a change in elevation, a rate of change in elevation, or the like, or combinations thereof.

As to particular embodiments, the computing element (13) can further include or be coupled to, whether wired or wirelessly, an ambient temperature sensor (49) and the computer program code (45) can include a temperature measurement module (50) which upon execution can determine an ambient temperature (52) based on a temperature sensor signal (51) generated by the ambient temperature sensor (49).

As to particular embodiments, the computing program code (45) can further include a travel route module (53) which upon execution can function to generate a travel route between a start point (54) and an end point (55) and, in cooperative action with the global positioning module (48), can provide directions to travel between the start point (54) and the end point (55).

As to particular embodiments, the computing element (13) can further include or be coupled to, whether wired or wirelessly, one or more biophysical sensors (56) which correspondingly sense one or more biophysical characteristics (57) of the user (4), whereby the one or more biophysical sensors (56) can be selected from the group including or consisting of: a tilt sensor (58), a vibration sensor (59), a temperature sensor (60), a blood pressure sensor (61), and a heart rate sensor (62). As to these embodiments of the computing element (13), the computer program code (45) can further include for each of the biophysical sensors (56) a corresponding biophysical sensor signal analyzer module (63) which upon execution can determine the corresponding biophysical characteristic (57) based on a biophysical sensor signal (71) generated by the biophysical sensor (56).

As to particular embodiments, the computer program code (45) can further include a viewable indicia generator module (64) which upon execution can generate a display of viewable indicia (11), whether in alpha or numeric characters (65), on the display surface (12) of the computing element (13) relating to one or more of a date or time, a measure of time, a pace or rate of travel, a count of steps, a current elevation, a change in elevation, a rate of change in elevation, an ambient temperature (52), directions, a biophysical characteristic (57), or the like, or combinations thereof.

As to particular embodiments, the computing element (13) can further include or be coupled to, whether wired or wirelessly, one or more user interfaces (66) and the computer program code (45) can further include and a user interface module (67) which upon execution allows the user (4) by click event, voice recognition, touch, or the like, to provide user input to set, adjust, or calibrate the various functionalities associated with execution of the modules (47)(48)(50)(53)(63)(64)(67) of the computer program code (45).

A method of producing a particular embodiment of the absorbent grip (1) can include providing a grippable body (5) having a grippable body length (26) disposed between a grippable body first end (22) and a grippable body second end (23), the grippable body (5) having a grippable body medial portion (24) configured to be gripped by a gripping element (2); and coupling an absorbent element (6) to the grippable body first end (22). As to particular embodiments, the gripping element (2) can include a hand (3) of a user (4).

The method of producing a particular embodiment of the absorbent grip (1) can further include configuring the grippable body medial portion (24) as a generally elongate cylinder. As to particular embodiments, a cylinder diameter (27) of the generally elongate cylinder can be in a range of between about 25 millimeters to about 50 millimeters. As to particular embodiments, the cylinder diameter (27) can be selected from the group including or consisting of: between about 25 millimeters to about 30 millimeters; between about 27.5 millimeters to about 32.5 millimeters; between about 30 millimeters to about 35 millimeters; between about 32.5 millimeters to about 37.5 millimeters; between about 35 millimeters to about 40 millimeters; between about 37.5 millimeters to about 42.5 millimeters; between about 40 millimeters to about 45 millimeters; between about 42.5 millimeters to about 47.5 millimeters; and between about 45 millimeters to about 50 millimeters.

The method of producing a particular embodiment of the absorbent grip (1) can further include configuring the grippable body length (26) in a range of between about 100 millimeters to about 150 millimeters. As to particular embodiments, the grippable body length (26) can be selected from the group including or consisting of: between about 100 millimeters to about 115 millimeters; between about 112.5 millimeters to about 117.5 millimeters; between about 115 millimeters to about 120 millimeters; between about 117.5 millimeters to about 122.5 millimeters; between about 120 millimeters to about 125 millimeters; between about 122.5 millimeters to about 127.5 millimeters; between about 125 millimeters to about 130 millimeters; between about 127.5 millimeters to about 132.5 millimeters; between about 130 millimeters to about 135 millimeters; between about 132.5 millimeters to about 137.5 millimeters; between about 135 millimeters to about 140 millimeters; between about 137.5 millimeters to about 142.5 millimeters; between about 140 millimeters to about 145 millimeters; between about 142.5 millimeters to about 147.5 millimeters; and between about 145 millimeters to about 150 millimeters.

The method of producing a particular embodiment of the absorbent grip (1) can further include removably coupling the absorbent element (6) to the grippable body first end (22). As to particular embodiments, the method can further include configuring the absorbent element (6) as a reusable absorbent element (6). As to other particular embodiments, the method can further include configuring the absorbent element (6) as a disposable absorbent element (6).

The method of producing a particular embodiment of the absorbent grip (1) can further include disposing an interior chamber (32) within the grippable body (5), whereby the interior chamber (32) has an interior chamber volume (70) defined by an interior chamber wall (35) configured to allow removable insertion and retention of an associated device (17). As to particular embodiments, the method can further include configuring the interior chamber (32) to allow interchangeable removable insertion and retention of a plurality of the associated devices (17). As to particular embodiments, the plurality of associated devices (17) can include one or more of the group consisting of: a container (19) configured to contain an amount of contained fluid (18), a light source (21) configured to generate a beam of light (20), a weight, and a self-defense device.

The method of producing a particular embodiment of the absorbent grip (1) can further include coupling a strap (39) to the grippable body (5) by coupling a strap first end (41) proximate the grippable body first end (2) and coupling a strap second end (42) proximate the grippable body second end (23). As to particular embodiments, the method can further include coupling a reflective element (16) to the strap (39).

The method of producing a particular embodiment of the absorbent grip (1) can further include coupling a computing element (13) to the absorbent grip (1), whereby the computing element (13) has a processor (46) in communication with a memory element (4) containing a computer program code (45) executable to generate one or more viewable indicia (11) on a display surface (12). As to particular embodiments, the method can further include providing computer program code (45) which includes a timer module (47).

The method of producing a particular embodiment of the absorbent grip (1) can further include operatively coupling a global positioning sensor (48) to the computing element (13), and further providing computer program code (45) which includes a global positioning module (72) configured to determine a location based on a global positioning sensor signal (73) generated by the global positioning sensor (48).

The method of producing a particular embodiment of the absorbent grip (1) can further include operatively coupling an ambient temperature sensor (49) to the computing element (13), and further providing computer program code (45) which includes a temperature measurement module (50) configured to determine an ambient temperature (52) based on a temperature sensor signal (51) generated by the ambient temperature sensor (49).

The method of producing a particular embodiment of the absorbent grip (1) can further include operatively coupling a biophysical sensor (56) to the computing element (13), and further providing computer program code (45) which includes a biophysical sensor signal analyzer module (63) configured to determine a biophysical characteristic (57) based on a biophysical sensor signal (71) generated by the biophysical sensor (56).

As to particular embodiments, the absorbent grip (1) or elements of the absorbent grip (1) can be produced from any of a wide variety of processes depending upon the application, such as press molding, injection molding, fabrication, machining, printing, three-dimensional printing, or the like, or combinations thereof, as one piece or assembled from a plurality of pieces into an embodiment of the absorbent grip (1) or provided as a plurality of pieces for assembly into an embodiment of the absorbent grip (1).

Now referring primarily to FIG. 1 and FIG. 2, a method of using a particular embodiment of the absorbent grip (1) can include grippably engaging a grippable body (5); and contacting an absorbent element (6) coupled to a grippable body first end (22) with a contactable surface (7), whereby the absorbent element (6) can be configured to absorb or displace fluids (9) or solid substances (10) from the contactable surface (7). As to particular embodiments, the contactable surface (7) can include a portion of a skin surface (8).

Now referring primarily to FIG. 1, FIG. 2, and FIG. 9, the method of using a particular embodiment of the absorbent grip (1) can further include operating an associated device (17) configured for removable insertion and retention within an interior chamber (32) disposed within the grippable body (5). As shown in the illustrative example of FIG. 2, the user (4) can disperse contained fluids (18) from a container (19) configured for removable insertion and retention within an interior chamber (32) disposed within the grippable body (5). The contained fluids (18), without limitation to the breadth of the foregoing, can include a rehydration fluid such as an amount of water, a sports drink, or the like; eye drops; an aerosol self-defense spray, such as mace; compressed gas; or the like. As shown in the illustrative example of FIG. 9, the user (4) can direct a beam of light (20) from a light source (21) configured for removable insertion and retention within an interior chamber (32) disposed within the grippable body (5).

Again referring primarily to FIG. 1, FIG. 2, and FIG. 9, the method of using a particular embodiment of the absorbent grip (1) can further include viewing reflective indicia (14) on a reflective surface (15) of a reflective element (16) coupled to the absorbent grip (1) to gain information about the physical environment, such as the proximity of vehicles, persons, animals, or the like, or combinations thereof

Again referring primarily to FIG. 1, FIG. 2, and FIG. 9, the method of using a particular embodiment of the absorbent grip (1) can further include viewing one or more viewable indicia (11) on a display surface (12) of a computing element (13) coupled to the absorbent grip (1) to obtain one or more of a date or time, a measure of time, a pace or rate of travel, a count of steps, a current elevation, a change in elevation, a rate of change in elevation, an ambient temperature (52), a travel route between a start point (54) and an end point (55), directions to travel between a start point (54) and an end point (55), a biophysical characteristic (57) such as body temperature, blood pressure, heart rate, or the like, or combinations thereof.

The method of using a particular embodiment of the absorbent grip (1) can further include uncoupling the absorbent element (6) from the grippable body first end (22). As to particular embodiments having the absorbent element (6) configured as a reusable absorbent element (6), the method can further include cleaning the reusable absorbent element (6) and recoupling the reusable absorbent element (6) to the grippable body first end (22). As to particular embodiments having the absorbent element (6) configured as a disposable absorbent element (6), the method can further include disposing of the disposable absorbent element (6).

As can be easily understood from the foregoing, the basic concepts of the present invention may be embodied in a variety of ways. The invention involves numerous and varied embodiments of an absorbent grip and methods for making and using such absorbent grips including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method teen. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of a “coupler” and even a “means for coupling.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the absorbent grips herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice versa as necessary to define the matter for which protection is sought by this application or by any subsequent application or continuation, division, or continuation in part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An absorbent grip, comprising:
a grippable body having a grippable body length disposed between a grippable body first end and a grippable body second end, said grippable body having a grippable body medial portion configured to be gripped by a gripping element; and
an absorbent element coupled to said grippable body first end.

2. The absorbent grip of claim 1, wherein said gripping element comprises a hand of a user.

3. The absorbent grip of claim 2, wherein said grippable body medial portion is configured as a generally elongate cylinder.

4. The absorbent grip of claim 3, wherein said generally elongate cylinder has a cylinder diameter in a range of between about 25 millimeters to about 50 millimeters.

5. The absorbent grip of claim 4, wherein said cylinder diameter is selected from the group consisting of: between about 25 millimeters to about 30 millimeters; between about 27.5 millimeters to about 32.5 millimeters; between about 30 millimeters to about 35 millimeters; between about 32.5 millimeters to about 37.5 millimeters; between about 35 millimeters to about 40 millimeters; between about 37.5 millimeters to about 42.5 millimeters; between about 40 millimeters to about 45 millimeters; between about 42.5 millimeters to about 47.5 millimeters; and between about 45 millimeters to about 50 millimeters.

6. The absorbent grip of claim 3, wherein said grippable body length is in a range of between about 100 millimeters to about 150 millimeters.

7. The absorbent grip of claim 6, wherein said grippable body length is selected from the group consisting of: between about 100 millimeters to about 115 millimeters; between about 112.5 millimeters to about 117.5 millimeters; between about 115 millimeters to about 120 millimeters; between about 117.5 millimeters to about 122.5 millimeters; between about 120 millimeters to about 125 millimeters; between about 122.5 millimeters to about 127.5 millimeters; between about 125 millimeters to about 130 millimeters; between about 127.5 millimeters to about 132.5 millimeters; between about 130 millimeters to about 135 millimeters; between about 132.5 millimeters to about 137.5 millimeters; between about 135 millimeters to about 140 millimeters; between about 137.5 millimeters to about 142.5 millimeters; between about 140 millimeters to about 145 millimeters; between about 142.5 millimeters to about 147.5 millimeters; and between about 145 millimeters to about 150 millimeters.

8. The absorbent grip of claim 2, wherein said absorbent element removably couples to said grippable body first end.

9. The absorbent grip of claim 8, wherein said absorbent element comprises a reusable absorbent element.

10. The absorbent grip of claim 8, wherein said absorbent element comprises a disposable absorbent element.

11. The absorbent grip of claim 8, further comprising an interior chamber disposed within said grippable body, said interior chamber having an interior chamber volume defined by an interior chamber wall configured to allow removable insertion and retention of an associated device.

12. The absorbent grip of claim 11, said interior chamber configured to allow interchangeable removable insertion and retention of a plurality of said associated devices.

13. The absorbent grip of claim 12, wherein said plurality of associated devices includes one or more of the group consisting of: a container configured to contain an amount of contained fluids, a light source configured to generate a beam of light, a weight, and a self-defense device.

14. The absorbent grip of claim 8, further comprising a strap having a strap length disposed between a strap first end coupled proximate said grippable body first end and a strap second end coupled proximate said grippable body second end.

15. The absorbent grip of claim 14, further comprising a reflective element coupled to said strap.

16. The absorbent grip of claim 8, further comprising a computing element having a processor in communication with a memory element containing a computer program code executable to generate one or more viewable indicia on a display surface.

17. The absorbent grip of claim 16, wherein said computer program code further comprises a timer module.

18. The absorbent grip of claim 16, further comprising a global positioning sensor operatively coupled to said computing element, wherein said computer program code further comprises a global positioning module configured to determine a location based on a global positioning sensor signal generated by said global positioning sensor.

19. The absorbent grip of claim 16, further comprising an ambient temperature sensor operatively coupled to said computing element, wherein said computer program code further comprises a temperature measurement module configured to determine an ambient temperature based on a temperature sensor signal generated by said ambient temperature sensor.

20. The absorbent grip of claim 16, further comprising a biophysical sensor operatively coupled to said computing element, wherein said computer program code further comprises a biophysical sensor signal analyzer module configured to determine a biophysical characteristic based on a biophysical sensor signal generated by said biophysical sensor.

21-50. (canceled)
